(19) United States
(12) Patent Application Publication
(10) Pub. No.: US 2023/0335834 A1
(43) Pub. Date: Oct. 19, 2023

(54) SYSTEM AND METHOD FOR OPTIMIZED PERFORMANCE OF METAL-AIR FUEL CELLS

(71) Applicant: LOG 9 MATERIALS SCIENTIFIC PRIVATE LIMITED, BENGALURU (IN)

(72) Inventors: AKSHAY VIVEK SINGHAL, BANGALORE (IN); PRITHVI KADADARAVALLI BASAVARAJU, HASSAN (IN); ANKUSH RAINA, Jammu Tawi (IN); HEMANT CHARAYA, HISAR (IN)

(21) Appl. No.: 18/024,923

(22) PCT Filed: Sep. 4, 2021
(86) PCT No.: PCT/IN2021/050856

§ 371 Date: Mar. 6, 2023

(30) Foreign Application Priority Data
Sep. 24, 2020 (IN) 202041038256

(51) Int. Cl. H01M 12/02; H01M 4/12; H01M 12/06

(52) U.S. Cl. CPC H01M 12/02; H01M 4/12; H01M 12/065

(57) ABSTRACT

The embodiments of the present invention provide a system for optimizing a performance of metal-air fuel cells. The system includes the metal-air fuel cells comprising a plurality of stacks of metal-air fuel cell units. The plurality of stacks of metal-air fuel cell units are designed to be connected in at least one of a series configuration and a parallel configuration. Each metal-air fuel cell unit comprises at least one metal anode sheet placed between at least two cathodes sheets. One or more cathode electrodes (111) are held together with one of an epoxy and a silicone based elastomer adhesive. The at least one metal anode sheet and the at least two cathode sheets are included in a shell apparatus.

### CROSS-REFERENCE TO RELATED APPLICATIONS

This application is a national stage application of the Patent Cooperation Treaty (PCT) international stage application titled “SYSTEM AND METHOD FOR OPTIMIZED PERFORMANCE OF METAL-AIR FUEL CELLS”, numbered PCT /IN2021/050856, filed at the International Bureau of the World Intellectual Property Organization (WIPO) on Sept. 4, 2021. The aforementioned PCT international phase application claims priority to and the benefit of the provisional patent application titled “SYSTEM AND METHOD FOR OPTIMIZED PERFORMANCE OF METAL-AIR FUEL CELLS”, application number 202041038256, filed in the Indian Patent office (IPO) on Sept. 4, 2020. The specifications of the above referenced patent applications are incorporated herein by reference in their entirety.

### BACKGROUND

### Technical Field

The present disclosure generally relates to metal-air fuel cells. The present disclosure particularly relates to a system and a method for enabling an optimized performance of the metal-air fuel cells. The present disclosure more particularly related to a system and a method for enabling continuous and improved functioning of the metal-air fuel cells. The present disclosure further relates to an apparatus for enabling effective electrode and electrolyte management in the metal-air fuel cells.

### Description of the Related Art

Ever since its discovery, electricity has always been an in-demand form of energy. The ability to produce, store, use and convert it into any other form of energy are some of the reasons for the widespread use and its indispensability in today’s world. An ever-growing demand has also resulted in the need for constantly improving and inventing different ways of producing and storing electrical energy.

One of the most convenient ways to utilize electrical energy in a portable and scalable manner is batteries and fuel cells. Of the different types of batteries and fuel cells currently available, metal-air fuel cells offer better energy density, cleaner operation and non-hazardous by-products as compared to other forms of batteries. However, there are some challenges that exist in the use of metal-air fuel cells that are preventing their widespread use in multiple applications.

The metal-air fuel cells utilize an electrochemical reaction, where anode is fabricated from a pure metal, along with an external cathode in an aqueous electrolyte. The metal anode acts as a sacrificial electrode by providing the electrons needed for the reaction. The metal anode loses its mechanical and chemical integrity and hence it must be periodically replaced once it is completely consumed to sustain the generation of electricity. Also, the by-product produced as a result of the electrochemical process is to be effectively removed along with the anode to ensure a proper functioning of the metal-air fuel cell.

In order to provide a sustainable electrochemical reaction to provide enough energy, it is necessary to have a plurality of metal-air fuel cell units connected in series. This poses some mechanical design challenges that affect the physical and chemical environment of the metal-air fuel cell. For instance, there arises a requirement to maintain the electrolyte level within optimum limits in the fuel cell, such that the temperature of the electrolyte is maintained uniformly throughout the fuel cell. This requires specialized channels and arrangement for flow of electrolyte. Also, the pressure gradient is to be minimal across the level of electrolyte in the metal-air fuel cell.

Currently, there are also no available systems which safely enable removal of hydrogen that is produced from parasitic reaction undergoing in the system. This poses serious safety concerns, due to which the use of metal-air fuel cells is restricted and not widespread. Also, one other serious impediment to their use is the lack of a system that enables a non-cumbersome and scalable method to replace a plurality of used metal anode sheets from the metal-air fuel cell.

Hence there is a need for a system that enables an optimized and safe operation of the metal-air fuel cells. Also there is a need for enabling a portable and scalable use of the metal-air fuel cells without compromising on the safety of the operating conditions and their optimal performance.

The abovementioned shortcomings, disadvantages and problems are addressed herein, which will be understood by reading and studying the following specification.

### OBJECT OF THE EMBODIMENTS

The primary object of the present invention is to provide a system and a method for enabling an optimized performance of metal-air fuel cells.

Another object of the present invention is to provide the system for enabling effective electrode and electrolyte management in the metal-air fuel cells.

Yet another object of the present invention is to provide a system and a method for enabling continuous and enhanced functioning of the metal-air fuel cells.

Yet another object of the present invention is to enable a portable and scalable use of the metal-air fuel cells without compromising on the safety of operating conditions.

Yet another object of the present invention is to enable a portable and scalable use of the metal-air fuel cells without compromising on an optimal performance.

Yet another object of the present invention is to provide a system of the metal-air fuel cells that comprise a plurality of cell stacks that are easily assembled and disassembled, by integrating and disjoining individual cells units, respectively.

Yet another object of the present invention is to provide a design of the metal-air fuel cell that comprises a plurality of stacks of metal-air fuel cell units, where each of the stacks is designed to comprise up to fifty individual cell units.

Yet another object of the present invention is to provide a design of a metal-air fuel cell where the individual cell units in a single stack are flow-coupled together, which enables all the cells in the stack to get filled together with an electrolyte when the system gets into an operation.

Yet another object of the present invention is to provide a predetermined air gap between individual cells in a stack in the metal-air fuel cell system to allow a passage of air and ensure availability of oxygen to the air cathode at all times.

Yet another object of the present invention is to enable the individual cells units with a cathode support structure that mechanically supports the air cathodes to withstand the hydrostatic and flow pressure of the electrolyte.

Yet another object of the present invention is to provide an efficient and non-cumbersome way to replace a plurality of anode electrodes in the metal-air fuel cells.

Yet another object of the present invention is to provide a mechanism for an easy replacement of the consumed anode plates with the fresh ones, thereby refueling the system in an efficient and easy manner.

Yet another object of the present invention is to enable a uniform consumption of anode plates across their surfaces, such that the anode places get thinner uniformly with time during the system’s operation.

Yet another object of the present invention is to provide a scalable way of electrically connecting a plurality of metal-air fuel cells in series and/or parallel configuration.

Yet another object of the present invention is to enable an effective management of electrolyte flow in metal-air fuel cells.

Yet another object of the present invention is to enable the electrolyte flow to maintain a uniform dissolution of anode plates across all cells flow-coupled together in a single cell stack.

Yet another object of the present invention is to provide a system to maintain a minimum pressure gradient across the level of electrolyte in metal-air fuel cells.

Yet another object of the present invention is to enable a pressure gradient across a cell stack such that all active area in each cell is flooded with electrolyte, thereby maintaining a similar power output from each cell.

Yet another object of the present invention is to enable a convenient removal of by-products produced due to the electrochemical reaction in metal-air fuel cells.

Yet another object of the present invention is to provide large sized flow-nozzles each of the shell apparatus, such that the cell unit is not clogged by the by-product produced during the system operation.

Yet another object of the present invention is to provide a system to maintain the temperature of a metal-air fuel cell within an acceptable range.

Yet another object of the present invention is to enable the electrolyte present in each cell at any given time during the system operation to flow directly in to the electrolyte tank without spilling over to the other cells in the stack.

Yet another object of the present invention is to provide a mechanism for rapid dissipation of hydrogen gas produced by the electrochemical system, thereby preventing the system from reaching flammable limits.

These and other objects and advantages of the present invention will become readily apparent from the following detailed description taken in conjunction with the accompanying drawings.

### BRIEF SUMMARY OF THE EMBODIMENTS

The various embodiments of the present invention provide a system for enabling continuous and improved functioning of metal-air fuel cells. The present invention is also related to the system for enabling effective electrode and electrolyte management in metal-air fuel cells.

In an embodiment, a system for enabling the working of metal-air fuel cells is provided. The metal-air fuel cell is an enclosed apparatus comprising a plurality of stacks of metal-air fuel cell units, where the stacks are designed to be connected in series and/or parallel configurations. Each stack comprises a plurality of metal-air fuel cell units, where every metal-air fuel cell unit comprises one metal anode sheet that is designed to be placed between two cathodes sheets. The cathode is carbon sheets reinforced with thin sheets of mesh layer for providing mechanical support for the cathode and stop it from buckling. The cathode electrodes are held together with epoxy or silicone based elastomer adhesives which do not react with the alkaline environment. A shell apparatus houses the anode and cathode sheets, and also provides the mechanical means for the functioning of each metal-air fuel cell unit. The fuel cell’s main body is fabricated from materials which provide a non-reactive and inert environment to the electrochemical reactions taking place in the cell.

In an embodiment, a shell apparatus is provided to house each of the metal-air fuel cell units in a stack of metal-air fuel cells. The shell apparatus comprises cavities for housing one anode and two cathode electrodes. The cavities are designed such that the metal anode is slid inside a hollow cavity in the shell, and a separator arrangement provides mechanical separation between the anode and cathode sheets.

In an embodiment, a cap arrangement is provided to hold the anode metallic sheet in place inside the shell apparatus. The cap arrangement acts as the electrical connection between the anode of one cell unit and the plurality of other anodes in other cell units. The cap arrangement is designed to connect the cell units in series and/or parallel configurations. The cap arrangement also enables the installation and removal of a plurality of anode electrodes in metal-air fuel cells. There are a plurality of mechanical protrusions and cavities in the cap to enable safe housing for the metal anode, provide electrical connection to a plurality of cell units in a stack and also enable effective removal of gases produced as by-product during the electrochemical reaction in the cell unit.

In an embodiment, a plurality of nozzles is provided in each of the individual shell apparatus. The shell apparatus comprises a plurality of nozzles on its surface to enable the flow of electrolyte. The nozzles are classified into top, middle and bottom based on their location on the shell apparatus. The nozzles are designed to be interchangeably used as inlet, drain and overflow nozzles. The nozzles in every shell apparatus of a stack are pathways for the electrolyte that flows in and out from a centralized reservoir. The nozzles are designed to maintain the electrolyte level in the metal-air fuel cell at optimum level, such that the electrolyte level in all the cell units are the same so the pressure gradient is same across all cell units. Since the power produced by the cell is determined by the electrolyte in the cell, the nozzles maintain the level of electrolyte also in the cells. The nozzles also prevent the overflow of electrolyte from top of the cell.

In an embodiment, the nozzles are configured to act as inlet, drain and overflow pathways. When the bottom nozzles act as inlet, the electrolyte level rises up and drains out of the middle nozzles. When the in-flow of electrolyte is more, the top nozzles act as overflow nozzle and enable electrolyte to flow out. When the middle nozzles act as inlet, the bottom nozzles act as drain nozzles. When the in-flow is more, the top nozzles act as overflow nozzle. When the top nozzles act as inlet, the bottom nozzles act as the drain. Since the shell apparatus are all connected with one another, a centrally controlled mechanism maintains a balance between the in-flow and out-flow, thus maintaining the level of electrolyte and electrolyte in each of the cell units housed in the shell apparatus.

In an embodiment, an electrolyte flow control system is provided. The system comprises a tank of electrolyte, a pump and a plurality of sensors throughout the metal-air fuel cell to measure a plurality of real-time parameters such as the liquid level, temperature, pressure, pH value and viscosity. Depending on the real-time conditions in the cell, and the power requirement from the cell, the control system adjusts the level of electrolyte in the cell by adjusting the flow rate of the liquid in and out of the cell. A notch is provided to ensure that the drain electrolyte flows back into the tank.

In an embodiment, the system further includes one or more snap-fit interlocking mechanism, an anode chamber opening, a cathode support structure, an excess sludge collection area, a laminar channel, wherein the laminar channel enables sludge flow to the excess sludge collection area, and a guideway, wherein the guideway slides an anode plate into the main cell body.

In an embodiment, the snap-fit interlocking mechanism is arranged in a vertical direction, wherein the snap-fit interlocking mechanism is arranged in a horizontal direction.

In an embodiment, the anode plate comprises an electrical connection protrusion with a hole on a left top and a protrusion in a right top for mechanical connection.

In an embodiment, the system further includes a connector holes to fit a connector cap with a top cap of the metal-air fuel cell units, a cell connector connecting the cathode of the present cell with anode of other cells in series, at least one gas holes for gases to escape from the cell without affecting the electrical activity, a mechanical fastener to fix the electrode connection with the cell cap, a snap-fit lock mechanism to snap the metal anode plate to the main cell body, and a dovetail mechanism to provide mechanical stability to the assembly by holding the assembly in place.

The various embodiments of the present invention provide a method for providing an optimizing performance of metal-air fuel cells. The method includes forming a plurality of stacks of metal-air fuel cell units by assembling unit cells together such that the unit cells are in flow and electrically coupled together with consecutive cells. Further, the method includes controlling a gradient parameter in electrolyte levels across the plurality of stacks of metal-air fuel cell units by appropriately positioning and size of inflow nozzles of each cell. Further, the method includes controlling spillover of the electrolyte from one cell unit to other cell unit in the plurality of stacks of metal-air fuel cell units by positioning a bottom drain nozzle in the cell units. Further, the method includes maintaining high connectivity levels between the terminals of metal anode such that electrical connections are maintained by mounting metal anodes to grooves in a connector plate using snap fit extensions, provided on each side of the metal anode. Further, the method includes allowing a replacement of metal anodes once consumed during operation of the cell stack by mounting the metal anodes to the connector plate, which is coupled with the cell stack through a snap fit configuration.

In an embodiment, the gradient parameter in electrolyte levels across the cell stack is controlled by appropriately positioning and size of inflow nozzles of each cell, so as to ensure that all cell units have the same power output

These and other aspects of the embodiments herein will be better appreciated and understood when considered in conjunction with the following description and the accompanying drawings. It should be understood, however, that the following descriptions, while indicating the preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates an isometric view of a shell apparatus, according to one embodiment of the present invention.

FIG. 2 illustrates a sectional view of the shell apparatus, according to one embodiment of the present invention.

FIG. 3 illustrates an exploded view of an assembly of a cell unit and the shell apparatus, according to one embodiment of the present invention.

FIG. 4 illustrates an isometric view of a cap arrangement, according to one embodiment of the present invention.

FIG. 5 illustrates a front-view of the cap arrangement, according to one embodiment of the present invention.

FIG. 6 illustrates an exploded isometric view of an exemplary stack assembly of cell units and the shell apparatus, according to one embodiment of the present invention.

FIG. 7 is a process flowchart illustrating an exemplary method for optimizing performance of metal-air fuel cells, according to one embodiment of the present invention.

Although the specific features of the present invention are shown in some drawings and not in others. This is done for convenience only as each feature may be combined with any or all of the other features in accordance with the present invention.

### DETAILED DESCRIPTION OF THE INVENTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that other changes may be made without departing from the scope of the embodiments. The following detailed description is therefore not to be taken in a limiting sense.

According to one embodiment of a system for enabling the working of metal-air fuel cells is provided. The metal-air fuel cell is an enclosed apparatus comprising a plurality of stacks of metal-air fuel cell units, where the stacks are designed to be connected in series and/or parallel configurations. Each stack comprises a plurality of metal-air fuel cell units, where every metal-air fuel cell unit comprises one metal anode sheet that is designed to be placed between two cathodes sheets. The cathode is carbon sheets reinforced with thin sheets of mesh layer for providing mechanical support for the cathode and stop it from buckling. The cathode electrodes are held together with adhesives that are epoxy/silicone elastomer based and do no react with the alkaline environment. A shell apparatus houses the anode and cathode sheets, and also provides the mechanical means for the functioning of each metal-air fuel cell unit. The fuel cell’s main body is made up of materials that provide a non-reactive and inert environment to the electrochemical reactions taking place in the cell.

The system enables the continuous and improved functioning of metal-air fuel cells. In the system, a plurality of cell stacks is easily assembled and disassembled by respectively integrating and disjoining multiple individual metal-air cell units. The individual cell units in a single stack are flow-coupled together enabling all the cells in the stack to get filled together with the electrolyte when the system gets into operation. The system also enables an easy replacement of the consumed anode plates with the fresh ones, thereby easily refueling the system. The pressure gradient across a cell stack is maintained such that all active area in each cell is flooded with electrolyte, thus maintaining a similar power output from each cell. The system includes a mechanism for rapid dissipation of Hydrogen produced by the system to preventing it from reaching flammable limits. The system also enables effective electrode and electrolyte management in metal-air fuel cells.

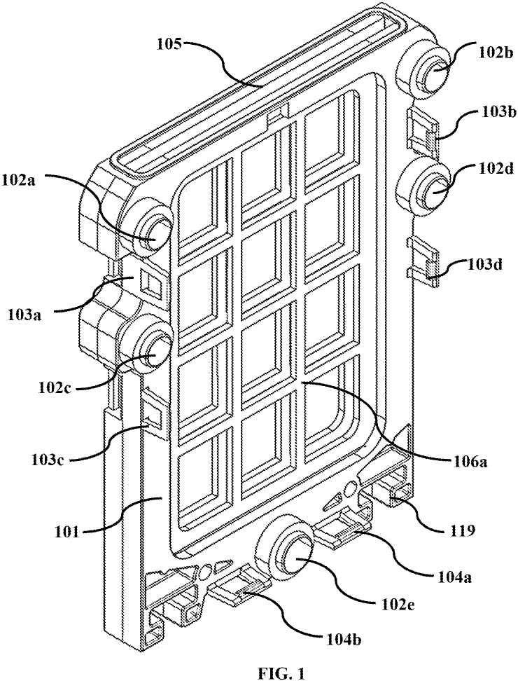

Referring now to the drawings and more particularly to FIGS. 1 through 7, where similar reference characters denote corresponding features consistently throughout the figures, there are shown preferred embodiments.

FIG. 1 illustrates an isometric view of a shell apparatus, according to one embodiment of the present invention. As shown in the FIG. 1, the shell apparatus includes a main cell body (101), one or more nozzles (102a-102e), a snap-fit interlocking mechanism (103a-103d) arranged in a vertical direction, a snap-fit interlocking mechanism (104a-104b) arranged in a horizontal direction, an anode chamber opening (105), and a cathode support structure (106a and 106b), and a dovetail mechanism (119) to provide mechanical stability to the assembly by holding the assembly in place.

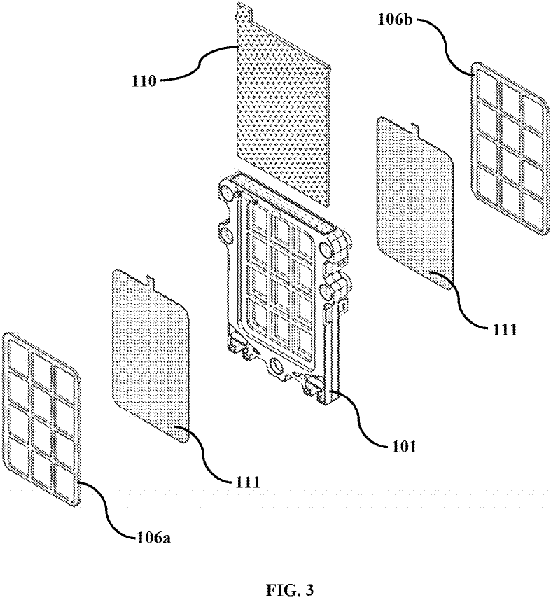

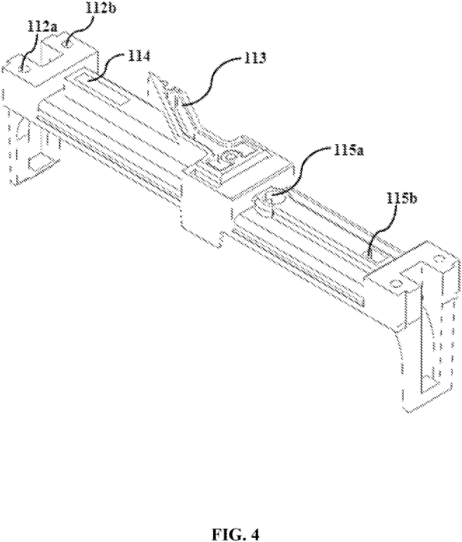

In an embodiment, the shell apparatus is provided to house each of metal-air fuel cell units in a stack of metal-air fuel cells. The shell apparatus comprises cavities (114) (as shown in the FIG. 4) for housing one anode and two cathode electrodes (111) (as shown in the FIG. 3). The cavities (114) are designed such that the metal anode is slid inside a hollow cavity in the shell apparatus, and a separator arrangement provides mechanical separation between the anode and cathode sheets.

In an embodiment, a cap arrangement is provided to hold the anode metallic sheet in place inside the shell apparatus. The cap arrangement acts as the electrical connection between the anode of one cell unit and the plurality of other anodes in other cell units. The cap arrangement is designed to connect the cell units in series and/or parallel configurations. The cap arrangement also enables the installation and removal of a plurality of anode electrodes in metal-air fuel cells. There are a plurality of mechanical protrusions and cavities in the cap to enable safe housing for the metal anode, provide electrical connection to a plurality of cell units in a stack and also enable effective removal of gases produced as by-product during the electrochemical reaction in the cell unit.

In an embodiment, a plurality of nozzles (102a-102e) is provided in each of the shell apparatus. The shell apparatus comprises the plurality of nozzles (102a-102e) on its surface to enable the flow of electrolyte. The nozzles (102a-102e) are classified into top, middle and middle based on their location on the shell apparatus. The nozzles (102a-102e) are designed to be interchangeably used as inlet, drain and overflow nozzles. The nozzles (102a-102e) in every shell apparatus of a stack are pathways for the electrolyte that flows in and out from a centralized reservoir. The nozzles (102a-102e) are designed to maintain the water level in the metal-air fuel cell at optimum level, such that the water level in all the cell units is the same so the pressure gradient is same across all cell units. Since the power produced by the cell is determined by the electrolyte in the cell, the nozzles maintain the level of electrolyte also in the cells. The nozzles also prevent the overflow of liquid from top of the cell.

In an embodiment, the nozzles (102a-102e) are configured to act as inlet, drain and overflow pathways. When the bottom nozzles act as inlet, the electrolyte level rises up and drains out of the middle nozzles. When the in-flow of electrolyte is more, the top nozzles act as overflow nozzle and enable electrolyte to flow out. When the middle nozzles act as inlet, the bottom nozzles act as drain nozzles. When the in-flow is more, the top nozzles act as overflow nozzle. When the top nozzles act as inlet, the bottom nozzles act as the drain. Since the shell apparatus are all connected with one another, a centrally controlled mechanism maintains a balance between the in-flow and out-flow, thus maintaining the level of electrolyte and electrolyte in each of the cell units housed in the shell apparatus.

In an embodiment, an electrolyte flow control system is provided. The system comprises a tank of electrolyte, a pump and a plurality of sensors throughout the metal-air fuel cell to measure a plurality of real-time parameters such as the liquid level, temperature, pressure, pH value and viscosity. Depending on the real-time conditions in the cell, and the power requirement from the cell, the control system adjusts the level of electrolyte in the cell by adjusting the flow rate of the liquid in and out of the cell. A notch is provided to ensure that the drain electrolyte flows back into the tank.

According to an embodiment of the present invention, the main cell body (101) is fabricated from a material so as to provide a non-reactive and inert environment to the electrochemical reactions taking place in the metal-air fuel cells, and wherein the material includes polymer materials selected from a group consisting of PVC, ABS, c-PCV.

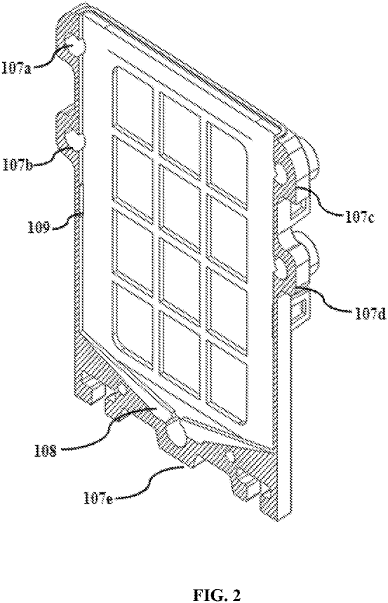

FIG. 2 illustrates a sectional view of the shell apparatus, according to one embodiment of the present invention. As shown in the FIG. 2, the shell apparatus further includes an excess sludge collection area (107a-107e), a laminar channel (108) to enable sludge flow to collection area (107a-107e), and a guideway (109) to slide anode plate (110) into the main cell body (101).

FIG. 3 illustrates an exploded view of an assembly of the cell unit and the shell apparatus, according to one embodiment of the present invention. As shown in the FIG. 3, the anode plate (110) further includes an electrical connection protrusion with a hole on left top and a protrusion in right top for mechanical connection. The assembly further comprises a cathode electrode (111).

FIG. 4 illustrates an isometric view of the cap arrangement, according to one embodiment of the present invention. As shown in the FIG. 4, the cap arrangement includes a connector holes (112a-112b) to fit the connector cap with top cap of the cell. A cell connector (113) connects the cathode of the present cell with anode of other cells in series. A cavity (114) is provided for the electrical connection protrusion of anode plate (110) to fit. A gas holes (115a and 115b) are provided for gases to escape from the cell without affecting the electrical activity.

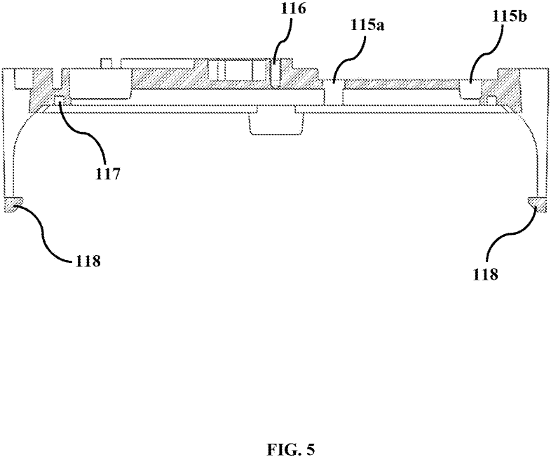

FIG. 5 illustrates a front-view of the cap arrangement, according to one embodiment of the present invention. As shown in the FIG. 5, the cap arrangement further includes a mechanical fastener (116) to fix the electrode connection with the cell cap, and a locking groove (117), where the protrusion provided in the metal anode rests to ensure it always remains connected to the electrode connectors and not breaking the circuit at any time. A snap-fit lock mechanism (118) snaps the metal anode plate 110 to the main cell body (101).

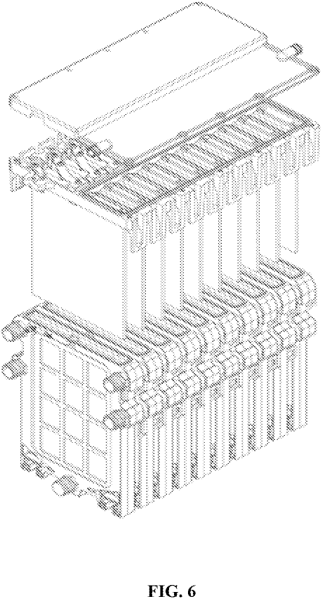

FIG. 6 illustrates an exploded isometric view of an exemplary stack assembly of cell units and shell apparatus, according to one embodiment of the present invention. The cell units and the shell apparatus are already explained in the FIG. 1 to FIG. 5.

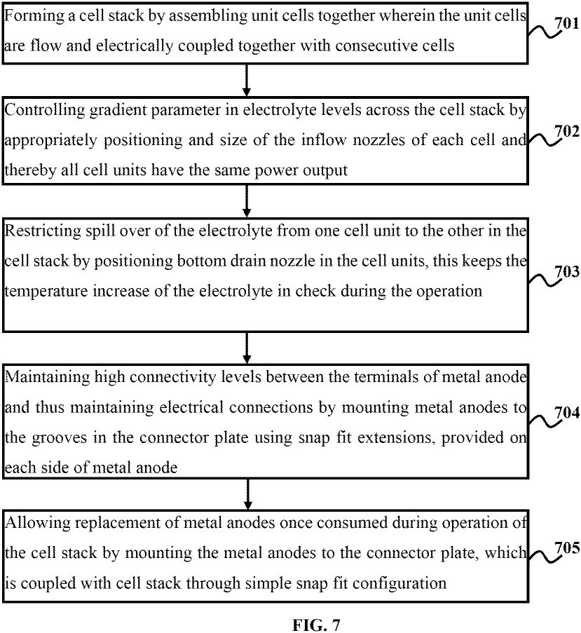

FIG. 7 is a process flowchart illustrating an exemplary method for optimizing performance of metal-air fuel cells, according to one embodiment of the present invention. a cell stack is formed by assembling unit cells together such that the unit cells are in flow & electrically coupled together with consecutive cells (701). A gradient parameter in electrolyte levels are controlled across the cell stack by appropriately positioning and size of the inflow nozzles of each cell, thereby ensuring that all cell units have the same power output (702).

Spillover of the electrolyte from one cell unit to the other in the cell stack is restricted by positioning bottom drain nozzle in the cell units (703). This keeps the temperature increase of the electrolyte in check during the operation. High connectivity levels between the terminals of metal anode is maintained and thus electrical connections are maintained by mounting metal anodes to the grooves in the Connector plate using snap fit extensions, provided on each side of metal anode (704). Replacement of metal anodes are allowed once consumed during operation of the cell stack by mounting the metal anodes to the connector plate, which is coupled with cell stack through simple snap fit configuration (705)

Although the embodiments herein are described with various specific embodiments, it will be obvious for a person skilled in the art to practice the embodiments herein with modifications.

### ADVANTAGES OF THE INVENTION

The embodiments of the present invention provide a system and method for enabling an optimized performance of metal-air fuel cells. The system also enables the effective electrode and electrolyte management in the metal-air fuel cells. Further, system enables the continuous and enhanced functioning of the metal-air fuel cells.

The embodiments of the present invention provide the metal-air fuel cells enabling a portable and scalable use of metal-air fuel cells without compromising on the safety of the operating conditions. The system enables the portable and scalable use of metal-air fuel cells without compromising on the optimal performance. The system includes a plurality of metal-air fuel cell stacks that are easily assembled and disassembled, by integrating and disjoining individual cells units, respectively. The design for metal-air fuel cells includes a plurality of stacks of metal-air fuel cell units, where each of the stacks is designed to comprise up to fifty individual cell units.

The embodiments of the present invention provide a design for metal-air fuel cells where the individual cell units in a single stack are flow-coupled together, which enables all the cells in the stack to get filled together with the electrolyte when the system gets into operation.

The embodiments of the present invention provide a metal-air fuel cells a predetermined air gap between individual cells in a stack in the metal-air fuel cell system to allow a passage of air and ensure availability of oxygen to the air cathode at all times. The embodiments of the present invention provide metal-air fuel cell system which enables the individual cells units with the cathode support structure that mechanically supports the air cathodes to withstand the hydrostatic and flow pressure of the electrolyte.

The embodiments of the present invention provide an efficient and non-cumbersome way to replace a plurality of anode electrodes in metal-air fuel cells. The embodiments of the present invention provide a mechanism for an easy replacement of the consumed anode plates with the fresh ones, thereby refueling the system in an efficient and easy manner.

The embodiments of the present invention provide metal-air fuel cell system which enables a uniform consumption of anode plates across their surfaces, such that the anode places get thinner uniformly with time during the system’s operation. The embodiments of the present invention provide a scalable way of electrically connecting a plurality of metal-air fuel cells in series and/or parallel configuration.

The embodiments of the present invention provide metal-air fuel cell system which enables an effective management of electrolyte flow in metal-air fuel cells. The embodiments of the present invention provide metal-air fuel cell system which enables the electrolyte flow to maintain a uniform dissolution of anode plates across all cells flow-coupled together in a single cell stack.

The embodiments of the present invention provide metal-air fuel cell system which enables to maintain a minimum pressure gradient across the level of electrolyte in metal-air fuel cells.

The embodiments of the present invention provide metal-air fuel cell system which enables a pressure gradient across a cell stack such that all active area in each cell is flooded with electrolyte, thereby maintaining a similar power output from each cell.

The embodiments of the present invention provide metal-air fuel cell system which enables a convenient removal of by-products produced due to the electrochemical reaction in metal-air fuel cells.

The embodiments of the present invention provide metal-air fuel cell system comprising large sized flow-nozzles each of the shell apparatus, such that the cell unit is not clogged by the by-product produced during the system operation.

The embodiments of the present invention provide metal-air fuel cell system which maintains the temperature of a metal-air fuel cell within an acceptable range.

The embodiments of the present invention provide metal-air fuel cell system which enables the electrolyte present in each cell at any given time during the system operation to flow directly in to the electrolyte tank without spilling over to the other cells in the stack.

The embodiments of the present invention provide a mechanism for rapid dissipation of hydrogen gas produced by the electrochemical system, thereby preventing the system from reaching flammable limits.

The foregoing description of the specific embodiments will so fully reveal the general nature of the embodiments herein that others can, by applying current knowledge, readily modify and/or adapt for various applications such as specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications. However, all such modifications are deemed to be within the scope of the claims.

What is claimed is:

1. A system for providing an optimized performance of metal-air fuel cells, wherein the system comprises:
the metal-air fuel cells comprising a plurality of stacks of metal-air fuel cell units, wherein the plurality of stacks of metal-air fuel cell units are designed to be connected in at least one of a series configuration and a parallel configuration;
wherein each stacks of the metal-air fuel cell units comprises a plurality of metal-air fuel cell units, where each metal-air fuel cell unit comprises at least one metal anode sheet placed between at least two cathodes sheets;
wherein at least one cathode electrode (111) is held together with one of an epoxy and a silicone based elastomer adhesive; and
wherein the at least one metal anode sheet and the at least two cathode sheets are included in a shell apparatus.

2. The system as claimed in claim 1, wherein the at least two cathodes sheets are reinforced with thin sheets of a mesh layer for providing mechanical support for the cathodes sheets and stop the cathodes sheets from buckling.

3. The system as claimed in claim 1, wherein the main cell body (101) is fabricated from a material so as to provide a non-reactive and inert environment to the electrochemical reactions taking place in the metal-air fuel cells, and wherein the material includes polymer materials selected from a group consisting of PVC, ABS, c-PCV.

4. The system as claimed in claim 1, wherein the shell apparatus houses each of the metal-air fuel cell units in the stack of metal-air fuel cells, wherein the shell apparatus comprises at least one cavity (114) for housing the at least one metal anode sheet and the at least one cathode electrodes (111).

5. The system as claimed in claim 4, wherein the at least one cavity (114) is designed such that the at least one metal anode sheet is slid inside a hollow cavity in the shell apparatus, and a separator arrangement provides mechanical separation between the at least one metal anode sheet and the at least one cathode sheet.

6. The system as claimed in claim 1, wherein the system comprises a cap arrangement for holding the at least one metal anode sheet inside the shell apparatus.

7. The system as claimed in claim 6, wherein the cap arrangement acts as an electrical connection between an anode of one metal-air fuel cell unit and the plurality of other anodes in other metal-air fuel cell units, wherein the cap arrangement is designed to connect the metal-air fuel cell units in at least one of the series configuration and the parallel configuration.

8. The system as claimed in claim 6, wherein the cap arrangement enables an installation and removal of a plurality of anode electrodes in the metal-air fuel cells, wherein the cap arrangement comprises a plurality of mechanical protrusions and cavities to enable safe housing for the at least one metal anode sheet, provide electrical connection to a plurality of cell units in a stack and enable removal of gases produced as by-product during the electrochemical reaction in the metal-air fuel cell units.

9. The system as claimed in claim 1, wherein the shell apparatus comprises a plurality of nozzles (102a-102e) to enable a flow of electrolyte from a centralized reservoir, wherein the plurality of nozzles (102a-102e) are designed to maintain a electrolyte level in the metal-air fuel cell at optimum level, such that the electrolyte level in all the metal-air fuel cell units is the same so the pressure gradient is same across all metal-air fuel cell units.

10. The system as claimed in claim 9, wherein the plurality of nozzles (102a-102e) maintain a level of electrolyte in the metal-air fuel cell units as the power produced by the metal-air fuel cell units is determined by the electrolyte in the metal-air fuel cell units, wherein the plurality of nozzles (102a-102e) prevent the overflow of liquid from the metal-air fuel cell units.

11. The system as claimed in claim 9, wherein the plurality of nozzles (102a-102e) is configured to act as an inlet, a drain and an overflow pathway.

12. The system as claimed in claim 11, wherein when a bottom nozzle act as an inlet, a electrolyte level rises up and drains out of the middle nozzles;
when an in-flow of electrolyte is more, a top nozzles act as overflow nozzle and enable electrolyte to flow out;
when a middle nozzles act as the inlet, a bottom nozzle acts as drain nozzles;
when the in-flow is more, the top nozzles act as overflow nozzle; and
when the top nozzles act as the inlet, the bottom nozzles act as the drain.

13. The system as claimed in claim 1, wherein the system includes a centrally controlled mechanism maintaining a balance between the in-flow and out-flow of electrolyte in the system, so as to maintain a level of water and electrolyte in each of the metal-air fuel cell units housed in the shell apparatus.

14. The system as claimed in claim 1, wherein the system includes an electrolyte flow control system, wherein the electrolyte flow control system comprises a tank of electrolyte, a pump and a plurality of sensors throughout the metal-air fuel cell to measure a plurality of parameters, wherein the plurality of parameters comprises a liquid level, temperature, pressure, pH value and viscosity.

15. The system as claimed in claim 14, wherein the electrolyte flow control system adjusts a level of electrolyte in the metal-air fuel cell units by adjusting the flow rate of the liquid in and out of the metal-air fuel cell units.

16. The system as claimed in claim 1, wherein the at least one cathode electrodes (111) are held together with epoxy or silicone based elastomer adhesives, so that the cathode electrodes (111) do not react with an alkaline environment.

17. The system as claimed in claim 1, wherein the system further comprises:
one or more snap-fit interlocking mechanism (103a-103d and 104a-104b);
at least one anode chamber opening (105);
at least one cathode support structure (106);
at least one excess sludge collection area (107a-107e);
at least one laminar channel (108), wherein the at least one laminar channel (108) enables sludge flow to the at least one excess sludge collection area (107a-107e); and
at least one guideway (109), wherein the at least one guideway (109) slides an anode plate (110) into the main cell body (101).

18. The system as claimed in claim 17, wherein the anode plate (110) comprises an electrical connection protrusion with a hole on a left top and a protrusion in a right top for mechanical connection.

19. The system as claimed in claim 1, wherein the snap-fit interlocking mechanism (103a-103d and 104a-104b) is arranged in at least one of a vertical direction and a horizontal direction.

20. The system as claimed in claim 1, wherein the system further comprises:
at least one connector hole (112a-112b) to fit a connector cap with a top cap of the metal-air fuel cell units;
a cell connector (113) connecting the cathode of the present cell with an anode of other cells in series;
at least one gas holes (115a and 115b) for gases to escape from the cell without affecting the electrical activity;
at least one mechanical fastener (116) to fix the electrode connection with the cell cap;
at least one snap-fit lock mechanism (118) to snap the metal anode plate (110) to the main cell body (101); and
a dovetail mechanism (119) to provide mechanical stability to the assembly by holding the assembly in place.

21. A method for providing an optimizing performance of metal-air fuel cells, comprises:
forming a plurality of stacks of metal-air fuel cell units by assembling unit cells together such that the unit cells are in flow and electrically coupled together with consecutive cells;
controlling a gradient parameter in electrolyte levels across the plurality of stacks of metal-air fuel cell units by appropriately positioning and size of inflow nozzles of each cell;
controlling spillover of the electrolyte from one cell unit to other cell unit in the plurality of stacks of metal-air fuel cell units by positioning a bottom drain nozzle in the cell units;
maintaining high connectivity levels between the terminals of metal anode such that electrical connections are maintained by mounting metal anodes to grooves in a connector plate using snap fit extensions, provided on each side of the metal anode; and
allowing a replacement of metal anodes once consumed during operation of the cell stack by mounting the metal anodes to the connector plate, which is coupled with the cell stack through a snap fit configuration.

22. The method as claimed in claim 21, wherein the gradient parameter in electrolyte levels across the cell stack is controlled by appropriately positioning and size of inflow nozzles of each cell, so as to ensure that all cell units have the same power output.
